(19) United States
(12) Patent Application Publication
(10) Pub. No.: US 2025/0217550 A1
(43) Pub. Date: Jul. 3, 2025

(54) SYSTEM AND METHOD FOR AI BASED SPACECRAFT SHIELDING DESIGN

(71) Applicant: Board of Supervisors of Louisiana State University and Agricultural and Mechanical College, Baton Rouge, LA (US)

(72) Inventors: Jeffery C. CHANCELLOR, Baton Rouge, LA (US); Jared TAYLOR, Baton Rouge, LA (US); Helmut Gottfried KATZGRABER, Kirkland, WA (US)

(21) Appl. No.: 18/841,963

(22) PCT Filed: Mar. 3, 2023
(86) PCT No.: PCT/US2023/063644

§ 371 Date: Aug. 27, 2024

Related U.S. Application Data
(60) Provisional application No. 63/316,832, filed on Mar. 4, 2022.

(51) Int. Cl. G06F 30/27; G06F 30/15; G06F 30/23; G06F 111/06; G06N 3/086

(52) U.S. Cl. CPC G06F 30/27; G06F 30/15; G06F 30/23; G06N 3/086; G06F 2111/06

(57) ABSTRACT

Methods, systems, and non-transitory computer-readable storage media for using Artificial Intelligence (AI) to determine optimal design framework and topology for space craft shielding. A system can receive measured extravehicular or intravehicular activity radiation fields and generate a plurality of shielding profiles. The system can then repeatedly execute an optimization algorithm until a minimum number of iterations is performed. The optimization algorithm can include: scoring each shielding profile with respect to the measured intravehicular activity radiation fields; pairing the shielding profiles within the plurality of shielding profiles, resulting in paired shielding profiles; for each pair of shielding profiles within the paired shielding profiles, selecting the shielding profile with the higher score as a parent profile, resulting in parent shielding profiles; generating new shielding profiles using pairs of the parent shielding profiles; and adding the new shielding profiles to the plurality of shielding profiles.

### PRIORITY

This application claims priority to U.S. provisional patent application No. 63/316,832, filed Mar. 4, 2022, the contents of which are incorporated herein in their entirety.

### BACKGROUND

### 1. Technical Field

The present disclosure relates to designing spacecraft shielding, and more specifically to using Artificial Intelligence (AI) to determine optimal design framework and topology for space craft shielding.

### 2. Introduction

Artificial Intelligence systems use a corpus of training data to train neural networks. These trained neural networks receive inputs, predict one or more outputs, and can provide feedback on how correct/incorrect the predicted output was. That feedback can be added to the corpus for a subsequent training of the neural network.

Spacecraft shielding profiles requires an understanding of engineering feasibility and the effects of different types of cosmic radiation on living creatures, particularly the effects on human beings. However, “optimizing” such designs to minimize the amount of radiation living beings would receive aboard such spacecraft is difficult because of the number of variables which can effect the creatures, the ability to provide meaningful feedback regarding the design, and the ability to iterate the design process.

### SUMMARY

Additional features and advantages of the disclosure is set forth in the description that follows, and in part is understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, measured extravehicular or intravehicular activity radiation fields; generating, via at least one processor of the computer system, a plurality of shielding profiles; and repeating, via the at least one processor executing an optimization algorithm, until a minimum number of iterations is performed: performing a fitness test on each shielding profile in the plurality of shielding profiles with respect to the measured intravehicular activity radiation fields, resulting in a fitness score for the each shielding profile; pairing, via the at least one processor, the shielding profiles within the plurality of shielding profiles, resulting in paired shielding profiles; for each pair of shielding profiles within the paired shielding profiles, selecting, via the at least one processor, the shielding profile with the higher fitness score as a parent profile, resulting in parent shielding profiles; generating, via the at least one processor, new shielding profiles using pairs of the parent shielding profiles; and adding the new shielding profiles to the plurality of shielding profiles.

A system configured to perform the concepts disclosed herein can include: at least one processor; and a computer-readable storage medium having instructions stored which, when executed by the at least one processor, cause the at least one processor to perform operations comprising: receiving measured extravehicular or intravehicular activity radiation fields; generating a plurality of shielding profiles; and repeating, via the at least one processor executing an optimization algorithm, until a minimum number of iterations is performed: performing a fitness test on each shielding profile in the plurality of shielding profiles with respect to the measured intravehicular activity radiation fields, resulting in a fitness score for the each shielding profile; pairing the shielding profiles within the plurality of shielding profiles, resulting in paired shielding profiles; for each pair of shielding profiles within the paired shielding profiles, selecting the shielding profile with the higher fitness score as a parent profile, resulting in parent shielding profiles; generating new shielding profiles using pairs of the parent shielding profiles; and adding the new shielding profiles to the plurality of shielding profiles.

A non-transitory computer-readable storage medium configured as disclosed herein can have instructions stored which, when executed by at least one processor, cause the at least one processor to perform operations which include: receiving measured extravehicular or intravehicular activity radiation fields; generating a plurality of shielding profiles; and repeating, via the at least one processor executing an optimization algorithm, until a minimum number of iterations is performed: performing a fitness test on each shielding profile in the plurality of shielding profiles with respect to the measured intravehicular activity radiation fields, resulting in a fitness score for the each shielding profile; pairing the shielding profiles within the plurality of shielding profiles, resulting in paired shielding profiles; for each pair of shielding profiles within the paired shielding profiles, selecting the shielding profile with the higher fitness score as a parent profile, resulting in parent shielding profiles; generating new shielding profiles using pairs of the parent shielding profiles; and adding the new shielding profiles to the plurality of shielding profiles.

### BRIEF DESCRIPTION OF THE DRAWINGS

FIG. 1 illustrates an example system embodiment;

FIG. 2 illustrates an example of randomized shielding profiles organized in a manner similar to chromosomes;

FIG. 3 illustrates an example of combining randomized shielding profiles according to genetic mixing;

FIG. 4 illustrates an example of crossover and mutation operators in shielding profiles;

FIG. 5A illustrates an example of building 3D shielding;

FIG. 5B illustrates an example of iteratively developing 3D shielding;

FIG. 6A illustrates an example of 3D shielding with sensitive equipment illustrated;

FIG. 6B illustrates an example of 3D shielding of a monostructural form;

FIG. 6C illustrates an example of 3D shielding with a heterostructural form;

FIG. 7 illustrates an example of a physical testing environment;

FIG. 8 illustrates an example method embodiment; and

FIG. 9 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Systems configured as disclosed herein use a machine learning (ML) framework to evaluate the shielding effectiveness of the candidate materials using an artificial intelligence (AI) based algorithm for topology optimization. Topology optimization is performed using a genetic algorithm (GA), which is an algorithm which modifies vectors in a manner similar to how living organisms pass genes from parents to children. For example, the GA described herein uses two different vectors describing shielding profiles, then uses portions of each of those profiles to generate a “child” profile. In this manner, GAs are heuristic search procedures using evolutionary computation to imitate the biological processes of reproduction and natural selection to solve for the fittest solutions. They can be used to find the optimal solution(s) to a given computational problem that maximizes, or minimizes, a particular function. GA's are based on the analogy of natural selection where individuals in a population compete for resources and mates, the fittest individuals in a population mate to create progeny, and each successive generation is better suited for their environment. The evolutionary algorithm allows for multi-objective optimization and does not require a strict objective equation for distributing materials. Additionally, because the interactions of the electromagnetic field in materials is complex, using a GA facilitates relating the shielding effectiveness (SE) to the intrinsic properties of the material(s) being considered for both the substrate and the shielding film. The evaluation of each shielding profile is done using a finite element time domain (FETD) method, which allows for the consideration of the shielding geometry, permeability, conductivity, excitations, and boundary constraints. The use of a GA is a form of machine learning/artificial intelligence because, overtime, the results from the GA result in improved outputs, in a manner similar to survival of the fittest within evolutionary biology. While the GA itself and associated scoring of the shielding profiles remain constant, the results continue to improve with each iteration. If the system reaches a point where scoring improvements are not occurring, the system may determine that the top profiles are sufficiently optimized.

Among the possible uses of the methods and systems described herein, two exemplary uses are optimizing shielding designs to protect spacecraft (e.g., satellites, rockets, and/or shuttles) against space radiation, and optimizing shielding designs to protect people and/or electronics from Electromagnetic Interference (EMI), which could be a targeted attack and/or nominal interference.

With respect to space radiation, among the many dangers associated with long duration space missions are the adverse health effects to astronauts and damage to equipment resulting from exposure to the space radiation environment. The main sources of this radiation are galactic cosmic rays (GCR) whose spectrum consists of highly energetic nuclei that originate outside our galaxy. In order to protect crew and equipment from both the short and long-term effects of radiation, shielding must be included in the vehicle. Traditional shielding techniques include using the aluminum required for structural support, indigenous vehicle infrastructure (e.g., life support equipment, thermal protection, etc.) and added panels of polyethylene where more shielding is needed. Typically the level of shielding is limited by the mass and volume restrictions of the vehicle. Optimized spacecraft shielding is increasingly important as upcoming missions are longer in duration and further away from Earth.

The space radiation environment can be separated into two major categories, nominal and off-nominal events. Off-nominal events are mainly solar particle events (SPEs). These are outbursts of highly energetic particles coming from magnetically disturbed regions of the sun. SPEs consist largely of low-LET (Linear Energy Transfer) protons with energies ranging up to GeV magnitude. These events can be a concern to the crew if they are very intense, or if there is inadequate shielding such as during extravehicular activity (EVA) or in a thinly shielded vehicle. SPEs are rapidly developing unpredictable events, usually lasting hours to days. The nominal environment is made up of solar wind, trapped radiation, and galactic cosmic rays. Solar wind is a constant flow of low energy particles from the Sun.

Trapped radiation consists of the electrons and protons trapped by Earth's magnetosphere. GCRs originate from outside our solar system. The spectrum is made up of approximately 87% protons and 12% alpha particles, with the remaining 1-2% of nuclei spanning the periodic table. These ions are a health threat to astronauts because of their large ionization power. The energy spectrum peaks at approximately 1 GeV per nucleon (GeV/n). At these energies, particles are difficult to shield because they are so penetrating due to the inverse relationship between energy loss and ion velocity. Thicker shielding could potentially provide more protection; however, shielding mass is limited by the capabilities of the spacecraft launch systems.

There is also significant concern for damage from ionizing radiation to electronics, both on manned vehicles and satellites. For example, it has been shown that high-energy radiation is a source of error in superconducting quantum devices. Ionizing radiation creates excess quasiparticles in superconductors which affects the qubit energy-relaxation time. Excess quasiparticles can also reduce sensitivity in kinetic inductance detectors and transition edge sensors used in astronomy. Radiation shielding has been used to help reduce these effects.

Some of the major categories for space radiation risks to human health made by NASA include: Risk of Acute and Late Central Nervous System Effects from Radiation Exposure, Risk of Degenerative Tissue or other Health Effects from Radiation Exposure, and Risk of Radiation Carcinogenesis. Degenerative tissue effects include adverse effects on the heart, circulatory, endocrine, digestive, lens, and other tissue systems. Damage to the central nervous system (CNS) could reduce performance in motor tasks and memory. These could be disastrous to the crew and cause mission failure. Genetic damage and carcinogenesis are also extremely important effects that greatly impact the quality and length of life of astronauts after they return to Earth. Delayed effects, including cancer, develop over time and can take years to show the damage. These long-term effects are attributed to the constant exposure to the low dose-rate GCR environment.

GCR nuclei are a constant source of high energy radiation that causes health risks to humans for long duration missions. These high energy particles cannot be completely shielded by current spacecraft shielding which nominally have the equivalent of 5-20 g/cm2 aluminum equivalent shielding. Recent approaches to shielding evaluation have been limited to low-Z materials such as hydrogenous polymers. The cost versus benefit of materials that are light, non-toxic and have good tensile strength may be limiting. The energies of the heavier GCR ions are so penetrating that shielding can only partially reduce the intravehicular doses. Thicker shielding could provide protection but is limited by the mass and volume restrictions of exploration vehicles and dependent upon the capabilities of spacecraft launch systems. Additionally, spallation occurring as GCR particles collide with shielding materials can result in cascade showers that produce progeny ions with much higher potential for biological destruction than the original particle. It may be more beneficial to use less shielding to allow these particles to pass through the vehicle unchanged. This further emphasizes the need for optimized shielding designed specifically for the radiation environment the vehicle is exposed to.

Systems configured as disclosed herein use a combination of topology optimization and a generative model. The topology optimization is done by using a genetic algorithm (GA), as described above. This is an evolutionary algorithm based on Darwin's theory of evolution. An evolutionary algorithm is a good choice for this problem as they excel in multi-objective optimization. In this case the objectives include minimizing variables such as dose, weight of vehicle, and cost of shielding materials. This GA algorithm also doesn't require a strict objective equation for distributing materials. Not requiring a strict objective equation is needed because the interactions of a mixed ion field in materials are complex and there is no easy relationship to relate dose to type and quantity of material. Ion energy loss and fragmentation cross sections are energy, particle, and material dependent, so Monte Carlo simulations are done to assess the performance of each plan. The generative model helps preserve diversity in the population, such that the final population of candidate shielding profiles will have diverse trade-offs in objectives.

The genetic algorithm uses a population-based approach. This means at each step in the optimization process there are many possible solutions. This has the advantage of parallel processing power as well as finding multiple optimal solutions which is important for multi-objective problems. As an example, the system can begin by using a population of 100 unique shielding profiles. With each iteration additional shielding profiles can be created and/or removed from the pool of potential shielding profiles when deemed obsolete.

In the algorithm used by systems configured as disclosed herein, shielding profiles are represented by a vector of design variables, called “chromosomes,” and the individual design variables are referred to as “genes.” First a grid is created that represents the allowed design space for shielding materials. This grid surrounding the satellite or other object is separated into predefined voxels (a voxel is a unit of graphic information that defines a point in three-dimensional space). These voxels can be assigned a material to create a shielding profile. To use the genetic algorithm, each design needs to be represented as a chromosome. A chromosome is a list of genes. In this case, each gene represents a particular voxel and the value for each gene represents the material assigned to that voxel. This allows for each shielding profile to be represented by a list of numbers. For example, a very basic vector could have three variables/genes, and be stored in memory as [A, B, C], with variables/genes A, B, C having binary or other values. This allows each shielding profile to be described by a vector of numbers so the system can use the operators required in the genetic algorithm.

Each shielding profile is evaluated by a fitness test. For example, the fitness test may be a combination of multiple metrics (e.g., three or more) used to assess the performance at the desired mission orbit ephemeris. This includes the energy deposition and radiation particulate fluence measured in a volume or phantom positioned at a specific location inside the vehicle, the weight of the shielding material, and the cost of the material. A Monte Carlo simulation can be used to transport the radiation environment through the vehicle. The highest performing profiles are used to create the next generation. This is done in a process called “breeding,” where new shielding profiles are created by operators such as crossover and mutation. Here a new chromosome or ‘child’ is created from either a clone of one of the parent chromosomes or a crossover operation that combines the two parent chromosomes. Each child then has a probability to mutate, which will change a section of the shielding profile to a new material. This helps introduce randomness and increases diversity of the population. The best performing plans will have the highest fitness scores in a population. This next generation is evaluated with the same fitness test and the process continues until the desired goals are reached.

Once every individual in a population has a fitness score, the selection process takes place. This is where the “parents” are chosen to create the next generation. This framework will use the tournament method for selection. This means two individuals are chosen at random from the population. The shielding profile with the higher fitness score is selected as a parent, while the shielding profile with the lower fitness score can be removed from the pool of potential/candidate shielding profiles (in some configurations the lower fitness score remains in the pool but is not selected as a parent in a given iteration). Two remaining shielding profiles are combined with a crossover operator to create two new solutions. This repeats according to the specified population size. Once the specified population size is met, shielding profiles may be removed based on scores, age, or other similar factors.

Monte Carlo simulations for the fitness test can be done with a Particle and Heavy Ion Transport System (PHITS). PHITS uses various nuclear reaction models and data libraries to model the transport of nearly all species of particles over a wide range of energy (10⁻⁵ eV to 1 TeV). This is a versatile system that is used in many fields such as nuclear technology, medical physics, accelerator design, and cosmic ray research.

The final generation in the genetic algorithm will consist of a set of Pareto-optimal solutions. These solutions will have diverse trade-offs in objectives. They can be further processed to choose a single preferred solution, depending on the requirements of the mission. Once a shielding profile has been selected, it can be optimized further using a simulated annealing algorithm. This will seek to further reduce dose by improving specific regions of the shielding profile. The regions altered is based on a directional approach of the highest flux of incoming particles to the location of interest.

A generative model can be added to this genetic algorithm. This can help to preserve diversity in the population while using a smaller population size, thereby reducing the computational cost of this framework. The generative model is a generative adversarial network (GAN). A GAN can train a generative model by framing the problem as a supervised learning problem with two sub-models: a generator model is trained to generate new examples, and a discriminator model that tries to classify examples as either real (from the domain) or fake (generated). The two models are trained together in a zero-sum game, adversarial, until the discriminator model is fooled about half the time, meaning the generator model is generating plausible examples.

The GAN can be used to rapidly create many unique shielding profiles that will help to increase the diversity of the population while attempting to maintain high performance. The genetic algorithm will pause while these new profiles are evaluated with the fitness test. After a specified number of iterations in the topology optimization process, the GAN the system creates uses those plans as input data. The generator model can then try to create new shielding profiles that replicate the real plans. The discriminator model can try to correctly label these shielding profiles as real (from topology optimization) or fake (from the generator model). These networks will train against each other until fake plans can be produced that replicate real plans. These new shielding profiles undergo the fitness test and are inserted back into the genetic algorithm in order to create more genetic diversity in the population. The end result are new shielding profiles that have similar distributions of materials to the input profiles. After this stage the genetic algorithm process continues until the desired goals are reached.

All calculations can be performed using high performance computing clusters, which help reduce computation time and allow more generations in the genetic algorithm. All simulations can be performed with the Particle and Heavy Ions Transport Code System (PHITS), an advanced 3D Monte Carlo simulator with a full event generator mode that can fully simulate all particles up to 200 GeV/n.

Systems configured as disclosed herein provide the ability to create a set of optimized shielding profiles with diverse trade-offs between objectives. This allows mission planners to have the best shielding options with flexibility to emphasize one or more objectives depending on the needs of the mission. This work is increasingly important as space agencies and commercial companies are moving towards longer and more frequent missions in space.

This framework is adaptable and can be used to optimize shielding for manned vehicles, satellites, lunar vehicles, or any other structure requiring radiation shielding. Systems and methods disclosed herein can be used to optimize shielding panels added to a structure, or in building the structure itself. If this framework is used to build the structure of a vehicle, additional fitness tests can be added to test and optimize the engineering requirements of the vehicle. With that description, we consider the specific examples illustrated in the figures.

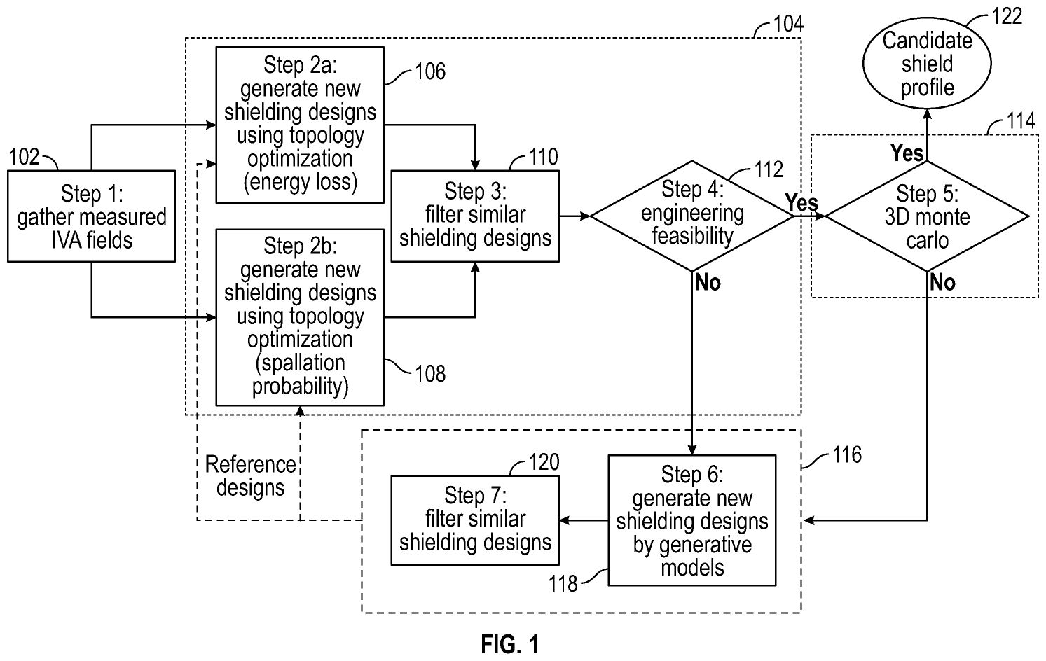

As illustrated in FIG. 1, the system can use computational dosimetry methods to identify shielding profiles that can minimize the ion species of the intravehicular cosmic ray spectrum that traverse the key organ sites of human beings. The first step 102 is to gather measured IVA (Intra Vehicular Activity) fields. For example, the system can use the measured intravehicular spectrums from the Columbus and US Lab Modules onboard the International Space Station during transit through high-latitude portions of the orbit as the reference radiation field.

During steps 2a 104 & 2b 108, new shielding profiles are generated using topology optimization 104. Here the system uses a hybrid of the solid isotropic material with penalization (SIMP) method that distributes matter parametrically by minimizing cost function(s) related to the material's (a) density, atomic weight, and ionization material and (b) density and fragmentation cross-section. The basic formulation for cost minimization can be written as d(x)=U^{T}MU. Where U is a displacement vector and M is a global matrix that defines the material's intrinsic properties that describe either energy loss (e.g. ionization potential, charge density, etc.), or spallation cross section (e.g. atomic mass, primary particle energy, etc.).

Steps 3 110 and 4 112 are implemented to reduce computational cost to irrelevant shielding profiles. In these steps, the framework filters shielding profiles using a set similarity benchmark based on a user determined threshold, and then makes pragmatic engineering decisions to discard impractical shielding profiles. During step 5 114, the shielding profile is evaluated using 3D Monte Carlo particle transport and the Computerized Anatomical Man (CAM) and Computerized Anatomical Female (CAF) to determine if there is a reduction of deleterious outcomes to the gastrointestinal (GI) system. Both the CAM and CAF can be used in order optimize for gender specific outcomes. The threshold for acceptance is based on relative change (negative or positive) of dose deposition within the GI system. If the shielding profile is rejected, steps 6 118 and 7 120 can use generative design 116 to create new shielding profiles after learning aggregated designs in the current iteration. Specifically, in step 6 118 the system can generate new shielding designs using generative models, and in step 7 120 can filter those new shielding designs based on similarity to known designs. The output(s) from steps 6 118 and 7 120 can be used as input into step 2b 108.

The outputs of the system are one or more shielding profiles 122 for minimizing the harmful human health outcomes following a space radiation exposure. This can be used to evaluate current shielding configurations on vehicles such as the International Space Station, SpaceX Dragon, or during new vehicle design for determining the optimum vehicle structure for radiation protection. The disclosed system can also be used for determining shielding/infrastructure for satellite assets (e.g., commercial, defense, and communication satellites) to minimize hardware disruption and single-event upsets due to interactions with cosmic rays.

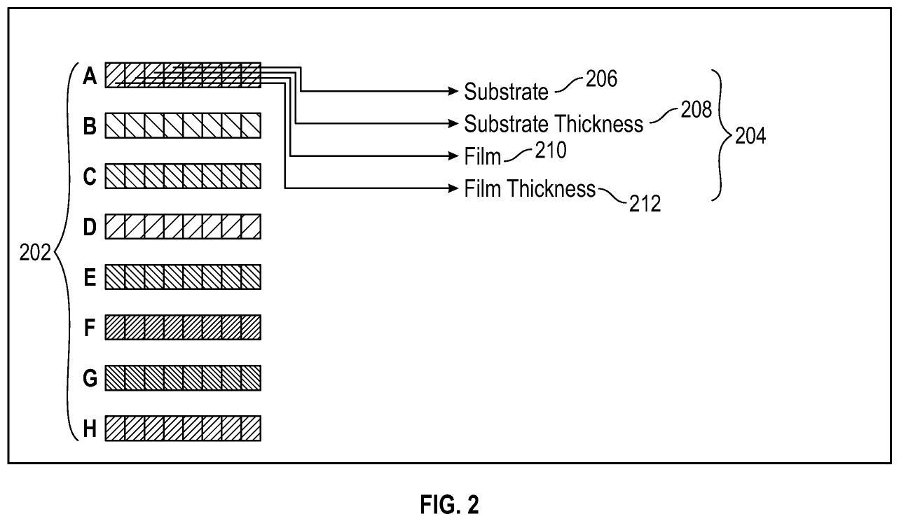

FIG. 2 illustrates an example of randomized shielding profiles 202 organized in a manner similar to chromosomes. Here the genetic representation for each candidate solution, e.g., its chromosome, having the intrinsic properties 204 of the substrates and films that could be mutated and altered into optimized shielding profiles by modifying aspects such as such as conductivity, thickness, permeability, etc. The entire algorithm is performed by randomly initializing a set of individuals in a population, p, where the shielding profiles are represented by a vector of design variables, e.g., the chromosomes. The fitness of the population is characterized with predetermined variables referred to as gene which are intrinsic material properties 204. Non-limiting examples of the intrinsic material properties 204 of the shielding profiles 202 can include properties such as substrate type 206, substrate thickness 208, film type 210, film thickness 212, conductivity, permeability, resistivity, tensile strength, thermal conductivity, melting point, etc. Genes are joined into a string/vector/array to form a chromosome, e.g., a solution set. The following is then repeated until convergence; (a) select parents from population, (b) crossover and generate new population, (c) perform mutation on new population, and (d) calculate the fitness for new population. Mutations can be based on (a) stopping power and (b) spallation cross-section.

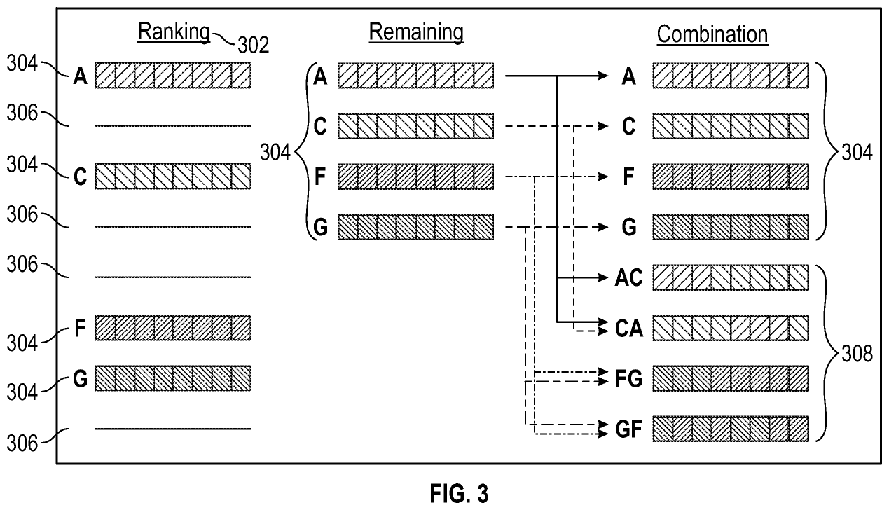

FIG. 3 illustrates an example of combining randomized shielding profiles according to genetic mixing, a visualization of genetic algorithm to test candidate HEMP shielding profiles 304, 306. First, a fitness test is used to evaluate these profiles, rank the profiles 302, and select the best profiles 304. As illustrated, the system can start off with a number of shielding profiles 304, 306, and conduct a fitness test to score how the shielding profiles 304, 306 perform. For example, the fitness test can be performed using the finite element time domain (FETD) method and determine scores for the shielding profiles based on the minimum HEMP shielding effectiveness requirements, in decibels, outlined in MIL-STD-188-125-1 for frequencies between 10³ Hz and 10¹¹ Hz. FETD, described below, can be chosen because it allows for utilizing a multigrid volumetric technique to accurately represent complex curvilinear geometries. The shielding profiles 304, 306 can then be ranked 302 based on their fitness test results, with the resulting best profiles 304 becoming the parents and the profiles 306 which are not the best being removed (or, depending on the configuration, they may remain but not be selected to become a parent).

In this example, only the top ranked shielding profiles 304 are preserved, and an offspring/child population 308 is then generated by crossing and mutation mechanisms. Offspring 308 can either be a clone of a parent chromosome or a crossover that combines the chromosomes of two (or more) parents based on a specified probability. Each offspring 308 then has a probability to mutate, which will change a section of the shielding profile to a new material based on (a) energy loss and (b) spallation cross-sections. This next generation will then be evaluated with the same fitness test and the best profiles becomes the new parent population. In some configurations, both the top ranked shielding profiles 304 and the offspring 308 can be used for future testing (e.g., the subsequent fitness test), whereas in other configurations only the offspring 308 will remain. The process continues until an optimal profile is reached or after a specified number of generations. An “optimal” profile can be determined, for example, when the fitness score fails to improve by a predetermined amount for a number of iterations, or when the fitness score indicates that radiation would be within a predetermined range (e.g., safe for humans, safe for electronics, etc.).

Finite Element Time Domain (FETD): FETD allows for utilizing a multigrid volumetric technique to accurately represent complex curvilinear geometries. FETD was specifically chose because it contains information about the shielding geometry, excitations, and boundary constraints that describe the interface between the substrate and the shielding material. It allows for small mesh elements to be defined using tetragonal geometries which make it possible to accurately represent complex curvilinear geometries that can be associated with defects in the fabrication process. The finite element is applied to the vector Helmholtz wave equation where edge elements are used to discretize and provide tangential field continuity across the material interfaces, correcting for any discontinuity across interfaces. Additionally, FETD is useful for modeling complex inhomogeneous configurations, thin metal surfaces, and tightly coupled and electrically small conductor materials. This is especially useful for calculating scattered or radiated fields from 3D objects where the geometry can vary on the scale of a fraction of the wavelength.

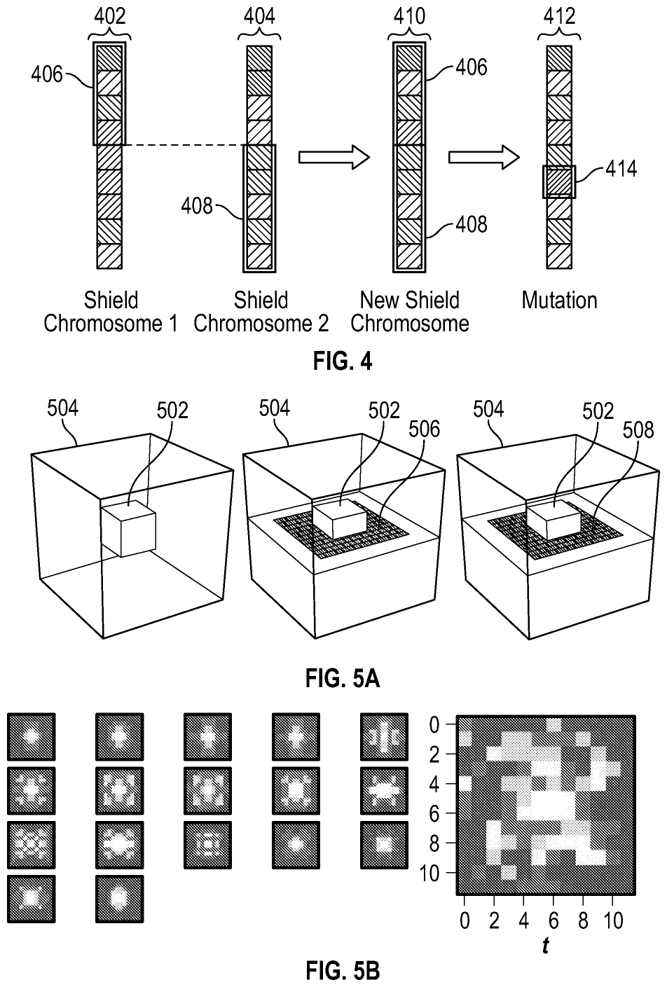

FIG. 4 illustrates an example of crossover and mutation operators in shielding profiles. The crossover operator is a method of combining two individual shielding profiles to produce two new shielding profiles. In one example, this involves taking two chromosomes and making a cut at a random gene. The top part 406 of chromosome 1 402 is combined with the bottom 408 of chromosome 2 404 to make one new solution 410 (with the top part 406 of the first chromosome 402 and the bottom part 408 of the second chromosome 404) while the remaining parts can be used to create a second solution. Then each child 410 has a probability to mutate, which can change a section 414 of the shielding profile to a new material based on (a) energy loss and (b) spallation cross-sections, resulting in a mutated child 412.

This next generation (i.e., 410 and/or 412) is then be evaluated with the same fitness test and the best profiles becomes the new parent population. The process continues until an optimal profile is reached or after a specified number of generations. In other examples, rather than a cut with a first contiguous portion of the chromosome/vector coming from one parent and the second portion coming from the other, the genes received by a child can be randomly selected from each parent. In yet other configurations, clusters of attributes can be selected, randomly or otherwise, from the respective parents.

FIG. 5A illustrates an example of building 3D shielding using a resulting shielding profile for a satellite operating in low-Earth orbit. Here sensitive avionics hardware 502 are positioned inside the allowed satellite volume 504. In the left figure, a 3D grid of voxel volumes are generated. In the center figure, a random grid of desired shielding materials 506 is then generated, filling the satellite volume 504 surrounding the sensitive avionics hardware 502. Different materials are represented by the shading. On the right, using topology optimization, new plans are generated by randomly changing the material 508 of some of the voxels based on the dose deposition resulting from cosmic rays is then scored in the sensitive hardware volume (for example, using the 3D Monte Carlo transport software PHITS (Particle and Heavy Ion Transport System)). Using topology optimization, new plans are generated by randomly changing the material of some of the voxels. These plans are then input into a GAN that can generate competing shielding profiles with similar data distributions as demonstrated in FIG. 5B.

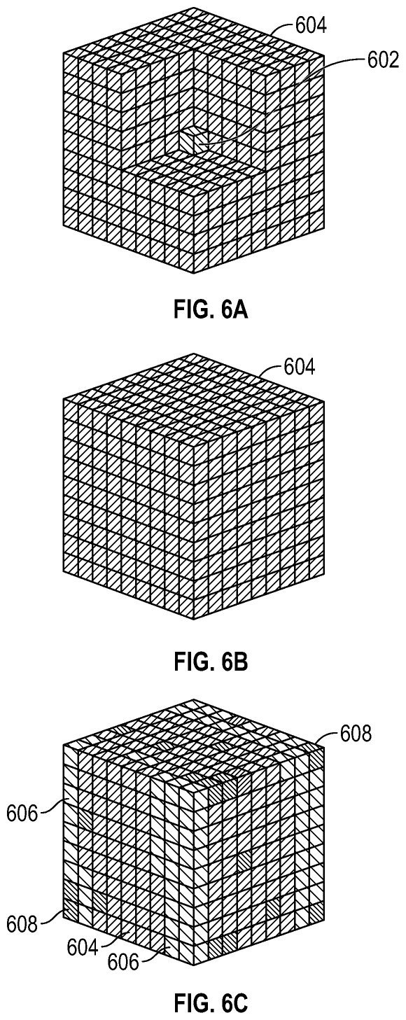

FIG. 6A illustrates an example of 3D shielding 604 with sensitive equipment 602 illustrated. Systems configured as disclosed herein can identify types of materials, locations, thicknesses, or other aspects of the shielding 604 which provide the best known protection for the sensitive equipment 602.

FIG. 6B illustrates an example of 3D shielding of a monostructural form. In this example, the shielding is monostructural, with materials surrounding the sensitive equipment 602 being a single type of type, and having identical (i.e., homogenous) attributes (e.g., thickness, orientation, etc.).

FIG. 6C illustrates an example of 3D shielding with a heterostructural form. In this example, the shielding is made up of materials with different attributes/qualities/thicknesses, etc. surrounding the sensitive equipment 602.

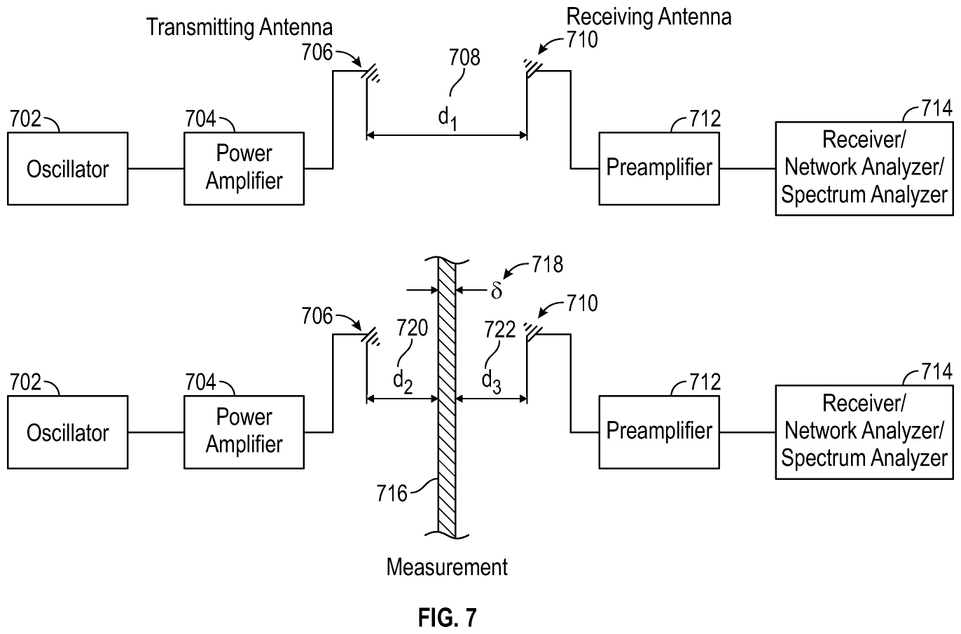

FIG. 7 illustrates an example of a physical testing environment. Once the top candidate shielding profiles have been selected (based on meeting selection criteria, number of iterations, etc.), it may be valuable to test the shielding design profiles. The physical testing configurations illustrated may be used for such tests—both for calibration of the equipment, and for testing (measuring) the effectiveness of the shield profiles.

The setup uses an oscillator 702 connected to a power amplifier 704, which in turn is connected to a transmitting antenna 706. On the receiving side is a receiving antenna 710, separated from the transmitting antenna 706 by a distance d₁ 708. The receiving antenna 710 is connected to a preamplifier 712, which in turn is connected to a receiver/network analyzer/spectrum analyzer 714. During operation/testing/measurement, the shield/electromagnetic barrier 716 is inserted between the transmitting antenna 706 and the receiving antenna 710, with a distance d₂ 720 between the shield 716 and the transmitting antenna 706, and a distance d₃ 722 between the shield 716 and the receiving antenna 706.

For example, shielding profile candidates may be chosen for evaluation at a laboratory capable of measuring electromagnetic shielding attenuation according to the standards outlined in MIL-STD-188-125-1, Appendix A. Testing frequencies may be scaled logarithmically within each decade, where the minimum density of test frequencies is defined as 10 kHz-100 kHz (20 frequencies), 100 kHz-1 MHz (20 frequencies), 1 MHz-10 MHz (40 frequencies), 10 MHz-100 MHz (150 frequencies, and 100 MHz-1 GHz (150 frequencies).

For each film, the substrate can be a given thickness and material, e.g., 125-mil aluminum. The films chosen can be, for example, cold-spray copper, cold-spray tantalum, and plasma spray tantalum. In such a configuration, shielding attenuation or other attributes may be measured. The shielding attenuation, which is the transmitted contribution to shielding 716 effectiveness, is determined by summing both the transmitted and the reflected waves impinging on a target (shield) 716 of consideration. Such a configuration and tests can be used to confirm that there is good agreement between the predicted versus measured shielding attenuation.

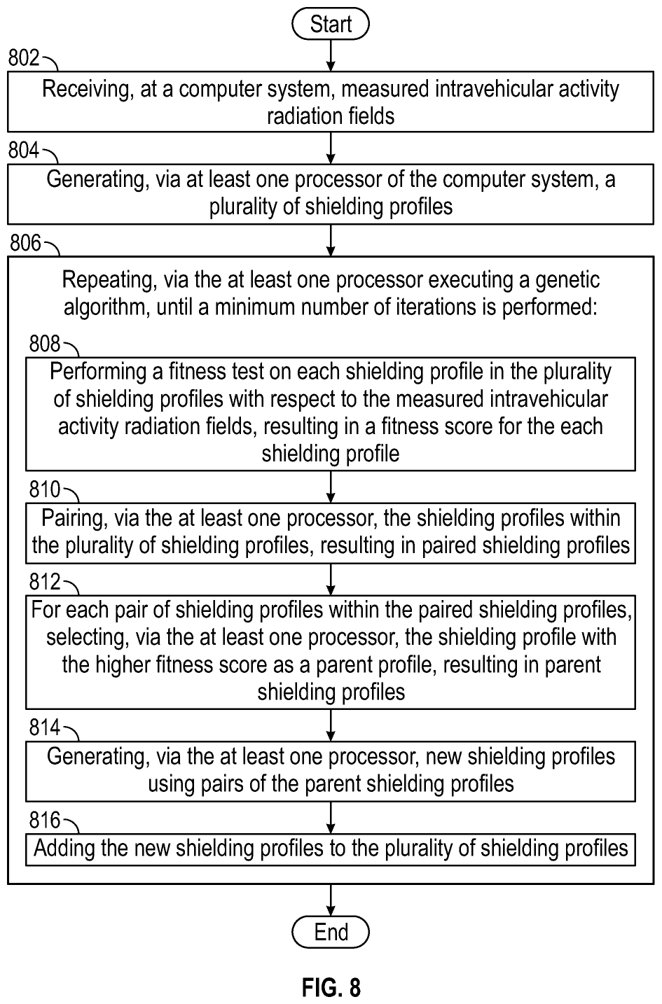

FIG. 8 illustrates an example method embodiment. As illustrated, the method can include: receiving, at a computer system, measured extravehicular or intravehicular activity radiation fields; generating, via at least one processor of the computer system, a plurality of shielding profiles; and repeating, via the at least one processor executing an optimization algorithm, until a minimum number of iterations is performed: performing a fitness test on each shielding profile in the plurality of shielding profiles with respect to the measured intravehicular activity radiation fields, resulting in a fitness score for the each shielding profile; pairing, via the at least one processor, the shielding profiles within the plurality of shielding profiles, resulting in paired shielding profiles; for each pair of shielding profiles within the paired shielding profiles, selecting, via the at least one processor, the shielding profile with the higher fitness score as a parent profile, resulting in parent shielding profiles; generating, via the at least one processor, new shielding profiles using pairs of the parent shielding profiles; and adding the new shielding profiles to the plurality of shielding profiles.

In some configurations, the fitness test can include: executing, via the at least one processor, an engineering feasibility analysis of the shielding profile, resulting in infeasible designs and feasible designs; and executing, via the at least one processor using the feasible designs, a three-dimensional Monte Carlo analysis, resulting in the fitness score. In such configurations, the three-dimensional Monte Carlo analysis can use a three-dimensional Monte Carlo particle transport, a Computerized Anatomical Man (CAM) model, and a Computerized Anatomical Female (CAF).

In some configurations, the method can further include: after the minimum number of iterations, identifying, via the at least one processor, a plurality of shielding profiles having associated fitness scores above a threshold, resulting in candidate shielding profiles. In such configurations, the at least one candidate shield profile can be selected based on a dose deposition of radiation within a gastrointestinal system of at least one of the CAM and the CAF.

In some configurations, the generating of the new shielding profiles uses a genetic algorithm, and the genetic algorithm can include a generative adversarial network (GAN).

In some configurations, the fitness test can use a solid isotropic material with penalization (SIMP) method which distributes matter parametrically by minimizing at least one cost function associated with at least one of: (1) density, atomic weight, and ionization material; and (2) density and fragmentation cross-section.

In some configurations, the measured intravehicular activity radiation fields are recorded from the International Space Station.

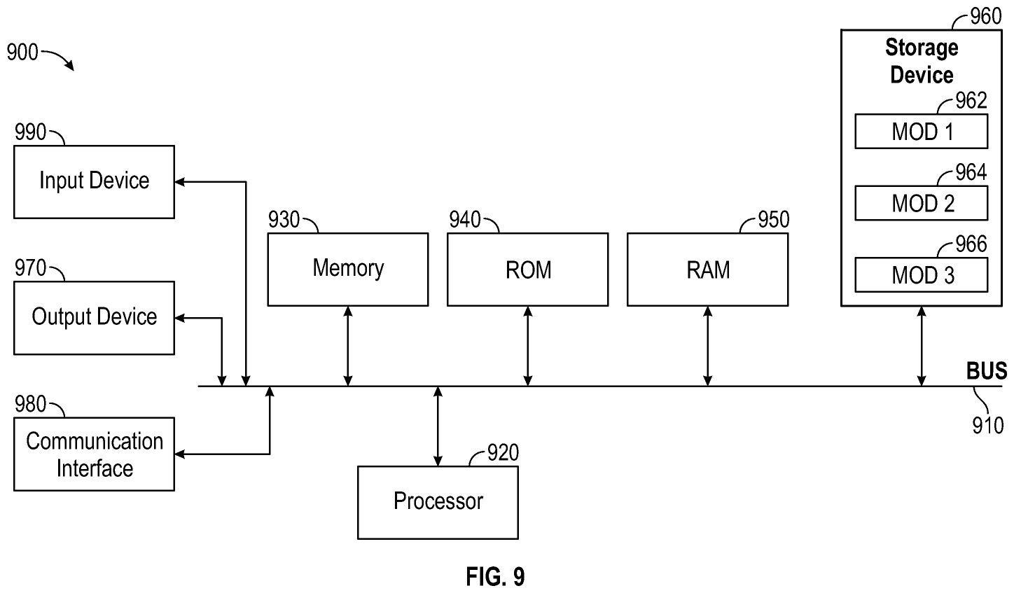

With reference to FIG. 9, an exemplary system includes a general-purpose computing device 900, including a processing unit (CPU or processor) 920 and a system bus 910 that couples various system components including the system memory 930 such as read-only memory (ROM) 940 and random access memory (RAM) 950 to the processor 920. The system 900 can include a cache of high-speed memory connected directly with, in close proximity to, or integrated as part of the processor 920. The system 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, bus 910, display 970, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 900 is a small, handheld computing device, a desktop computer, or a computer server.

Although the exemplary embodiment described herein employs the hard disk 960, other types of computer-readable media which can store data that are accessible by a computer, such as magnetic cassettes, flash memory cards, digital versatile disks, cartridges, random access memories (RAMs) 950, and read-only memory (ROM) 940, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Exemplary Testing. The following non-limiting example of actual testing results is for explanatory purposes only, and may vary in shape, size, number of iterations, or other variables according to the principles disclosed herein based on the specific needs of an embodiment.

The optimization described herein algorithm was tested on a simple representation of a satellite in free space. The satellite was represented by a cube divided into smaller cubic voxels 604 as shown in FIGS. 6A, 6B, and 6C. The total cube size was 36×36×36 cm³. There were 729 total voxels, with 9 in each direction. This made each voxel 4×4×4 cm³. The center voxel 602 represented the sensitive area of the satellite, where the dose was measured and minimized. This center voxel 602 was always filled with water to assess dose. Shielding profiles are created by changing the material in the surrounding voxels 604.

The source geometry used for the representative of the Galactic Cosmic Radiation (GCR) spectrum in free space was a spherical shell around the cube (illustrated in FIGS. 6A-6C). The shell had a radius of 31.5 cm, with a thickness of 0.1 cm. The particles were isotropically directed inwards from the sphere towards the cube.

The algorithm was run for 1000 generations. This was a preset generation limit based on computational resources available. Each generation was evaluated by the hyperarea metric. This refers to the area between the pareto front of the current generation and the reference. In this case the an aluminum cube (i.e., all the voxels were made of aluminum).

TABLE 1
Genetic Algorithm Results

| Generation | Hyperarea | % Change | Weight Range (kg) |
|---|---|---|---|
| 0 | — | — | — |
| 50 | 0.2167 | — | 38.01 |
| 100 | 0.2421 | 11.72% | 37.63 |
| 150 | 0.2693 | 11.24% | 38.10 |
| 200 | 0.2882 | 7.02% | 37.89 |
| 250 | .3053 | 5.93% | 35.22 |
| 300 | .3168 | 3.77% | 34.83 |
| 350 | .3102 | −2.08% | 34.83 |
| 400 | .3204 | 3.29% | 34.89 |
| 450 | .3294 | 2.81% | 35.64 |
| 500 | .3374 | 2.43% | 35.99 |
| 550 | .3337 | −1.10% | 34.55 |
| 600 | .3375 | 1.14% | 34.80 |
| 650 | .3644 | 7.97% | 35.18 |
| 700 | .3605 | −1.07% | 34.91 |
| 750 | .3641 | 1.00% | 34.84 |
| 800 | .3724 | 2.28% | 34.51 |
| 850 | .3775 | 1.37% | 34.71 |
| 900 | .3871 | 2.54% | 34.85 |
| 950 | .3740 | −3.38% | 34.75 |
| 1000 | .3740 | −0.02% | 34.98 |

Table 1 illustrates the genetic algorithm results, showing calculated hyperarea percent change, and the range in weight for the current population for every 50 generations throughout the optimization process. The weight restriction used had an upper limit of 40 kg. The percent change was calculated to keep track of changes for every 50 generations. This was used to ensure the optimization was continuing to improve. The other metric used was weight range. This took the difference in weight from the heaviest individual and lightest individual in the population. The purpose of this was to make sure the population explored the full design space in regards to possible weights. Each individual iteration was tested with an exposure to 400,000 particles using the radiation simulator source previously described.

Ten individual iterations with varying weights and shielding profiles were selected for further analysis. These shielding profiles were compared to the nearest weight aluminum reference (i.e., how do the genetic algorithmically designed shielding profiles compare to similarly weighted aluminum-only shield profiles). From these results we found a large reduction of dose around 15-20% for individuals up to 5 kg. We found around 5-10% improvement for individuals between 5 and 20 kg. And finally we found around 1-3% improvement between 20 and 40 kg. This low improvement for heavier individuals possibly occurred because the weight range decreased as the iterations continued, such that the population lost some of the heavier configurations (which otherwise would have been viable) due to the specific limits imposed by the tested weight requirement. In configurations without the weight requirement, the results may change.

We claim:

1. A method comprising:
receiving, at a computer system, measured extravehicular or intravehicular activity radiation fields;
generating, via at least one processor of the computer system, a plurality of shielding profiles; and
repeating, via the at least one processor executing an optimization algorithm, until a minimum number of iterations is performed:
performing a fitness test on each shielding profile in the plurality of shielding profiles with respect to the measured intravehicular activity radiation fields, resulting in a fitness score for the each shielding profile;
pairing, via the at least one processor, the shielding profiles within the plurality of shielding profiles, resulting in paired shielding profiles;
for each pair of shielding profiles within the paired shielding profiles, selecting, via the at least one processor, the shielding profile with the higher fitness score as a parent profile, resulting in parent shielding profiles;
generating, via the at least one processor, new shielding profiles using pairs of the parent shielding profiles; and
adding the new shielding profiles to the plurality of shielding profiles.

2. The method of claim 1, wherein the fitness test comprises:
executing, via the at least one processor, an engineering feasibility analysis of each shielding profile within the plurality of shielding profiles, resulting in infeasible designs and feasible designs; and
executing, via the at least one processor using the feasible designs, a three-dimensional Monte Carlo analysis, resulting in the fitness score.

3. The method of claim 2, wherein the three-dimensional Monte Carlo analysis uses a three-dimensional Monte Carlo particle transport, a Computerized Anatomical Man (CAM) model, and a Computerized Anatomical Female (CAF) model.

4. The method of claim 1, further comprising:
after the minimum number of iterations, identifying, via the at least one processor, a plurality of shielding profiles having associated fitness scores above a threshold, resulting in at least one candidate shielding profile.

5. The method of claim 4, wherein the at least one candidate shield profile is selected based on a dose deposition of radiation within a gastrointestinal system of at least one of the CAM model and the CAF model.

6. The method of claim 1, wherein the generating of the new shielding profiles uses a genetic algorithm, wherein the genetic algorithm comprises a generative adversarial network (GAN).

7. The method of claim 1, wherein the fitness test uses a solid isotropic material with penalization (SIMP) method which distributes matter parametrically by minimizing at least one cost function associated with at least one of: (1) density, atomic weight, and ionization material; and (2) density and fragmentation cross-section.

8. The method of claim 1, wherein the measured intravehicular activity radiation fields are recorded from the International Space Station.

9. A system, comprising:
at least one processor; and
a non-transitory computer-readable storage medium having instructions stored which, when executed by the at least one processor, cause the at least one processor to perform operations comprising:
receiving measured extravehicular or intravehicular activity radiation fields;
generating a plurality of shielding profiles; and
repeating execution of an optimization algorithm, until a minimum number of iterations is performed:
performing a fitness test on each shielding profile in the plurality of shielding profiles with respect to the measured intravehicular activity radiation fields, resulting in a fitness score for the each shielding profile;
pairing the shielding profiles within the plurality of shielding profiles, resulting in paired shielding profiles;
for each pair of shielding profiles within the paired shielding profiles, selecting the shielding profile with the higher fitness score as a parent profile, resulting in parent shielding profiles;
generating new shielding profiles using pairs of the parent shielding profiles; and
adding the new shielding profiles to the plurality of shielding profiles.

10. The system of claim 9, wherein the fitness test comprises:
executing an engineering feasibility analysis of each shielding profile within the plurality of shielding profiles, resulting in infeasible designs and feasible designs; and
executing, using the feasible designs, a three-dimensional Monte Carlo analysis, resulting in the fitness score.

11. The system of claim 10, wherein the three-dimensional Monte Carlo analysis uses a three-dimensional Monte Carlo particle transport, a Computerized Anatomical Man (CAM) model, and a Computerized Anatomical Female (CAF) model.

12. The system of claim 9, the non-transitory computer-readable storage medium having instructions stored which, when executed by the at least one processor, cause the at least one processor to perform operations comprising:
after the minimum number of iterations, identifying, via the at least one processor, a plurality of shielding profiles having associated fitness scores above a threshold, resulting in at least one candidate shielding profile.

13. The system of claim 12, wherein the at least one candidate shield profile is selected based on a dose deposition of radiation within a gastrointestinal system of at least one of the CAM model and the CAF model.

14. The system of claim 9, wherein the generating of the new shielding profiles uses a genetic algorithm, wherein the genetic algorithm comprises a generative adversarial network (GAN).

15. The system of claim 9, wherein the fitness test uses a solid isotropic material with penalization (SIMP) method which distributes matter parametrically by minimizing at least one cost function associated with at least one of: (1) density, atomic weight, and ionization material; and (2) density and fragmentation cross-section.

16. The system of claim 9, wherein the measured intravehicular activity radiation fields are recorded from the International Space Station.

17. A non-transitory computer-readable storage medium having instructions stored which, when executed by at least one processor, cause the at least one processor to perform operations comprising:
receiving measured extravehicular or intravehicular activity radiation fields;
generating a plurality of shielding profiles; and
repeating execution of an optimization algorithm, until a minimum number of iterations is performed:
performing a fitness test on each shielding profile in the plurality of shielding profiles with respect to the measured intravehicular activity radiation fields, resulting in a fitness score for the each shielding profile;
pairing the shielding profiles within the plurality of shielding profiles, resulting in paired shielding profiles;
for each pair of shielding profiles within the paired shielding profiles, selecting the shielding profile with the higher fitness score as a parent profile, resulting in parent shielding profiles;
generating new shielding profiles using pairs of the parent shielding profiles; and
adding the new shielding profiles to the plurality of shielding profiles.

18. The non-transitory computer-readable storage medium of claim 17, wherein the fitness test comprises:
executing an engineering feasibility analysis of each shielding profile within the plurality of shielding profiles, resulting in infeasible designs and feasible designs; and
executing, using the feasible designs, a three-dimensional Monte Carlo analysis, resulting in the fitness score.

19. The non-transitory computer-readable storage medium of claim 18, wherein the three-dimensional Monte Carlo analysis uses a three-dimensional Monte Carlo particle transport, a Computerized Anatomical Man (CAM) model, and a Computerized Anatomical Female (CAF) model.

20. The non-transitory computer-readable storage medium of claim 17, having instructions stored which, when executed by the at least one processor, cause the at least one processor to perform operations comprising:
after the minimum number of iterations, identifying, via the at least one processor, a plurality of shielding profiles having associated fitness scores above a threshold, resulting in candidate shielding profiles.
